(19) United States
(12) Patent Application Publication
(10) Pub. No.: US 2012/0096442 A1
(43) Pub. Date: Apr. 19, 2012

(54) COVERAGE APPARATUS AND METHOD FOR TESTING MULTITHREADING ENVIRONMENT

(76) Inventors: Hyo-Young Kim, Yongin-si (KR); Dae-Hyun Cho, Suwon-si (KR); Sung-Do Moon, Seongbam-si (KR)

(21) Appl. No.: 13/167,914

(22) Filed: Jun. 24, 2011

(30) Foreign Application Priority Data
Oct. 19, 2010 (KR) 10-2010-0102059

(51) Int. Cl. G06F 9/44

(52) U.S. Cl. 717/131

(57) ABSTRACT

A coverage technique for testing a multithreading environment is provided. The coverage technique schedules the execution order of mutually exclusive synchronization block pairs, wherein the mutually exclusive synchronization block pairs are defined by associating synchronization blocks that are detected from a plurality of threads each including synchronization blocks and can be simultaneously executed, to induce execution conflictions of the mutually exclusive synchronization blocks, thereby efficiently testing the corresponding multi-threaded application.

### CROSS-REFERENCE TO RELATED APPLICATION

This application claims the benefit under 35 U.S.C. §119(a) of Korean Patent Application No. 10-2010-0102059, filed on Oct. 19, 2010, the entire disclosure of which is incorporated herein by reference for all purposes.

### BACKGROUND

1. Field

The following description relates to coverage, and, more particularly, to a technique for testing multi-threaded applications.

2. Description of the Related Art

Due to mistakes made during the design of a program, unexpected variables encountered during the execution of the program, etc., a program may behave inefficiently or differently from a programmer's intention. Unexpected factors such as these that cause program to create undesired results are sometimes referred to as bugs or program errors. In order to avoid such bugs or program errors, testing of the program is essential in program development.

Program testing is particularly necessary in software development. However, conventional test methods have failed to provide definite criteria regarding thorough and complete program testing. Also, the conventional test methods do not ensure that all parts of a program have been executed. Further, the testing of all possible inputs is exceedingly difficult, if not in fact impossible, with these conventional test methods.

In order to overcome such problems, a concept of “coverage” has been introduced. Coverage refers to methods of determining whether to-be-tested parts in a program have all been tested. In general, coverage is carried out in such a manner as to define tasks to be measured and perform a test on the tasks until all the tasks are measured.

Coverage may be classified into several types according to the tasks to be measured. For example, function coverage measures whether all functions have been executed. Statement coverage measures whether all statements of a program have been executed.

Decision coverage measures whether a True/False operation has been executed at every branch node. Entry/Exit coverage measures whether all functions have been called and all return points in each function have been called. In addition to the above-described examples, there are various other coverage models.

For example, in statement coverage, which is the most common coverage model, statements are tasks, and the coverage includes checking whether all source code statements of a program have been executed, and when all source code statements are determined to have been executed, it is determined that 100% coverage is achieved.

Through such coverage methods, problems that could not be found by conventional test methods can be detected. Coverage has come to be regarded as important criteria for measuring various processing stages of testing during program development by allowing measurement regarding whether a test has been well done, determining how long a test has to be performed, and so on.

However, the above-described coverage models are not suitable to test multi-threaded applications in which a plurality of threads are simultaneously generated.

### SUMMARY

The following description relates to a coverage technique capable of efficiently testing multi-threaded applications.

In one general aspect, there is provided a coverage apparatus to test a multithreading environment, including a synchronization block searching unit configured to analyze a multi-threaded application, and to search for a plurality of synchronization blocks from the multi-threaded application, a synchronization block pair defining unit configured to detect mutually exclusive synchronization blocks, that are simultaneously executable, from a plurality of threads including found synchronization blocks, and to associate the detected mutually exclusive synchronization blocks to define one or more mutually exclusive synchronization block pairs, a scheduler configured to schedule an execution order of the mutually exclusive synchronization block pairs to induce execution conflictions of the mutually exclusive synchronization blocks, a coverage performing unit configured to execute the mutually exclusive synchronization block pairs in the scheduled execution order to perform coverage on the multi-threaded application, and to determine the result of the coverage performance, and a controller configured to analyze the result of the coverage performance to determine whether to continue to perform or terminate the coverage on the multi-threaded application.

The synchronization block pair defining unit may determine an execution precedence relationship between one synchronization block included in one thread and another synchronization block included in another thread, and may detect, in response to there being no execution precedence relationship between the two synchronization blocks, the two synchronization blocks as the mutually exclusive synchronization blocks.

The coverage performing unit may insert a first test unit and a second test unit, respectively, before and after synchronization blocks included in each of the plurality of threads, to test a first state in which a current synchronization block is executed later than another synchronization block forming a mutually exclusive synchronization block pair with the current synchronization block and thus waits before being executed, and a second state in which the current synchronization block is executed earlier than the other synchronization block forming the mutually exclusive synchronization block pair with the current synchronization block and thus delays the other synchronization block from being executed.

The first test unit may be added before the synchronization blocks included in each of the plurality of threads, and may determine whether the other synchronization block forming the mutually exclusive synchronization block pair with the current synchronization block waits to accomplish the second state, and may resume, in response to the other synchronization block waiting, execution of the other synchronization block.

In response to the other synchronization block forming the mutually exclusive synchronization block pair with the current synchronization block not waiting to accomplish the second state, the first test unit may determine whether the current synchronization block has to wait to accomplish the first state, and if it is determined that the current synchronization block has to wait to accomplish the first state, the first test unit may delay execution of the current synchronization block until the other synchronization block mutually exclusive from the current synchronization block is executed.

The second test unit may be added between the synchronization blocks included in each of the plurality of threads, and may determine whether the other synchronization block forming the mutually exclusive synchronization block pair with the current synchronization block waits to accomplish the first state, and may resume execution of the other synchronization block in response to the synchronization block waiting to accomplish the first state.

In response to the other synchronization block forming the mutually exclusive synchronization block pair with the current synchronization block not waiting to accomplish the first state, the second test unit may determine whether the current synchronization block has to wait to accomplish the second state, and if it is determined that the current synchronization block has to wait to accomplish the second state, the second test unit may stop execution of the current synchronization block and may wait until the other synchronization block mutually exclusive from the current synchronization block is executed.

In response to the mutually exclusive synchronization block pairs all being executed in the scheduled order, the controller may determine that coverage on the multi-threaded application is to be terminated.

In response to there being no change in the result of the coverage performance after coverage is repeatedly performed a predetermined number of times, the controller may determine that coverage on the multi-threaded application is to be terminated.

In another general aspect, there is provided a coverage method to test a multithreading environment, including analyzing a multi-threaded application, and searching for a plurality of synchronization blocks from the multi-threaded application, detecting mutually exclusive synchronization blocks, that are simultaneously executable, from a plurality of threads including found synchronization blocks, and associating the detected mutually exclusive synchronization blocks to define one or more mutually exclusive synchronization block pairs, scheduling an execution order of the mutually exclusive synchronization block pairs to induce execution conflictions of the mutually exclusive synchronization blocks, executing the mutually exclusive synchronization block pairs in the scheduled execution order to perform coverage on the multi-threaded application, and determining the result of the coverage performance, analyzing the result of the coverage performance and determining whether to continue to perform or terminate the coverage on the multi-threaded application, according to the analyzed result of the coverage performance.

The defining of the one or more mutually exclusive synchronization block pairs may include determining an execution precedence relationship between one synchronization block included in one thread and another synchronization block included in another thread, and detecting, in response to there being no execution precedence relationship between the two synchronization blocks, the two synchronization blocks as the mutually exclusive synchronization blocks.

The executing of the mutually exclusive synchronization block pairs in the scheduled execution order to perform coverage on the multi-threaded application may include inserting a first test unit and a second test unit, respectively, before and after synchronization blocks included in each of the plurality of threads, to test a first state in which a current synchronization block is executed later than another synchronization block forming a mutually exclusive synchronization block pair with the current synchronization block and thus waits before being executed, and a second state in which the current synchronization block is executed earlier than the other synchronization block forming the mutually exclusive synchronization block pair with the current synchronization block and thus delays the other synchronization block from being executed.

In the executing of the mutually exclusive synchronization block pairs in the scheduled execution order to perform coverage on the multi-threaded application, the first test unit may be added before the synchronization blocks included in each of the plurality of threads, and may determine whether the other synchronization block forming the mutually exclusive synchronization block pair with the current synchronization block waits to accomplish the second state, and may resume, in response to the other synchronization block waiting, execution of the other synchronization block.

In the executing of the mutually exclusive synchronization block pairs in the scheduled execution order to perform coverage on the multi-threaded application, in response to the other synchronization block forming the mutually exclusive synchronization block pair with the current synchronization block not waiting to accomplish the second state, the first test unit may determine whether the current synchronization block has to wait to accomplish the first state, and if it is determined that the current synchronization block has to wait to accomplish the first state, the first test unit may delay execution of the current synchronization block until the other synchronization block mutually exclusive from the current synchronization block is executed.

In the executing of the mutually exclusive synchronization block pairs in the scheduled execution order to perform coverage on the multi-threaded application, the second test unit may be added after the synchronization blocks included in each of the plurality of threads, and may determine whether the other synchronization block forming the mutually exclusive synchronization block pair with the current synchronization block waits to accomplish the first state, and may resume execution of the other synchronization block in response to the synchronization block waiting to accomplish the first state.

In the executing of the mutually exclusive synchronization block pairs in the scheduled execution order to perform coverage of the multi-threaded application, in response to the other synchronization block forming the mutually exclusive synchronization block pair with the current synchronization block not waiting to accomplish the first state, the second test unit may determine whether the current synchronization block has to wait to accomplish the second state, and if it is determined that the current synchronization block has to wait to accomplish the second state, the second test unit may stop execution of the current synchronization block and wait until the other synchronization block mutually exclusive from the current synchronization block is executed.

The determining of whether to continue to perform or terminate coverage on the multi-threaded application may include determining, in response to the mutually exclusive synchronization block pairs all being executed in the scheduled order, that coverage on the multi-threaded application is to be terminated.

The determining of whether to continue to perform or terminate coverage on the multi-threaded application may include determining, in response to there being no change in the result of the coverage performance after coverage is repeatedly performed a predetermined number of times, that coverage on the multi-threaded application is to be terminated.

In another general aspect, there is provided a coverage method of testing a multithreading environment, including detecting mutually exclusive synchronization blocks that are simultaneously executable from a plurality of threads, defining exclusive synchronization block pairs with pairs of the exclusive synchronization blocks detected in different threads, executing the mutually exclusive synchronization block pairs in various orders to perform coverage testing.

At least one of the mutually exclusive synchronization block pairs may be executed in a first order in which a first block is delayed until after a second block is executed, and in a second order in which the second block is delayed until after the first block is executed.

Therefore, by scheduling the execution order of mutually exclusive synchronization block pairs in such a manner so as to intentionally induce execution conflictions of the mutually exclusive synchronization blocks, wherein the mutually exclusive synchronization block pairs are defined by associating synchronization blocks that are detected from a plurality of threads each including two or more synchronization blocks and that can be simultaneously executed, it is possible to efficiently test multi-threaded applications.

Other features and aspects will be apparent from the following detailed description, the drawings, and the claims.

### BRIEF DESCRIPTION OF THE DRAWINGS

FIG. 1 is a diagram illustrating an example of a coverage apparatus for testing a multithreading environment.

FIG. 2 is illustrates an example of application source code.

FIG. 3 illustrates mutually exclusive synchronization block pairs defined by the application source code illustrated in FIG. 2.

FIG. 4 illustrates scheduling examples of the execution order of the mutually exclusive synchronization block pairs illustrated in FIG. 3.

FIG. 5 illustrates a state in which first and second test units are inserted into the application source code illustrated in FIG. 2.

FIG. 6 is a flowchart illustrating an example of operation of a first test unit.

FIG. 7 is a flowchart illustrating an example of operation of a second test unit.

FIG. 8 is a flowchart illustrating an example of a coverage method which is performed by a coverage apparatus for testing a multithreading environment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

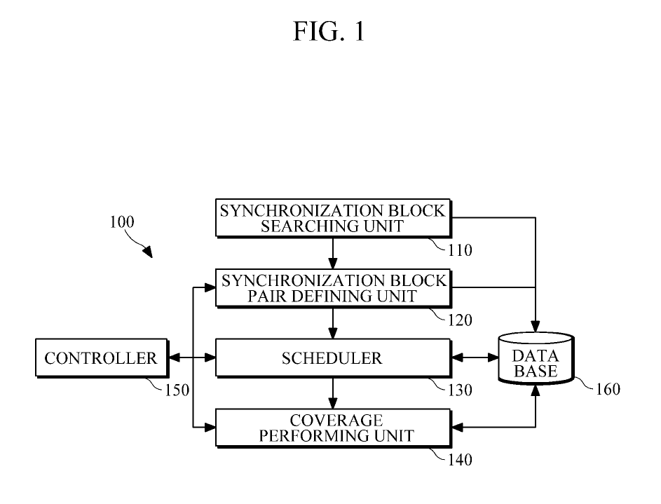

FIG. 1 is a diagram illustrating an example of a coverage apparatus 100 for testing a multithreading environment. As illustrated in FIG. 1, this example of the coverage apparatus 100 includes a synchronization block searching unit 110, a synchronization block pair defining unit 120, a scheduler 130, a coverage performing unit 140, and a controller 150.

The synchronization block searching unit 110 may analyze an application that will perform coverage to search for synchronization blocks from the application. A multi-threaded application includes synchronization blocks that are synchronized to a plurality of threads. The coverage apparatus 100 causes the synchronization block searching unit 110 to analyze an application that tries to perform coverage to detect synchronization blocks existing in the application, and stores the result of the analysis. For example, the results of the analysis of the synchronization block searching unit 110 may be stored in a data base 160. The data base 160 may be provided as an element of the coverage apparatus 100, or may be provided separately from the coverage apparatus 100. The data base 160 may be any type of memory component, such as a flash memory device.

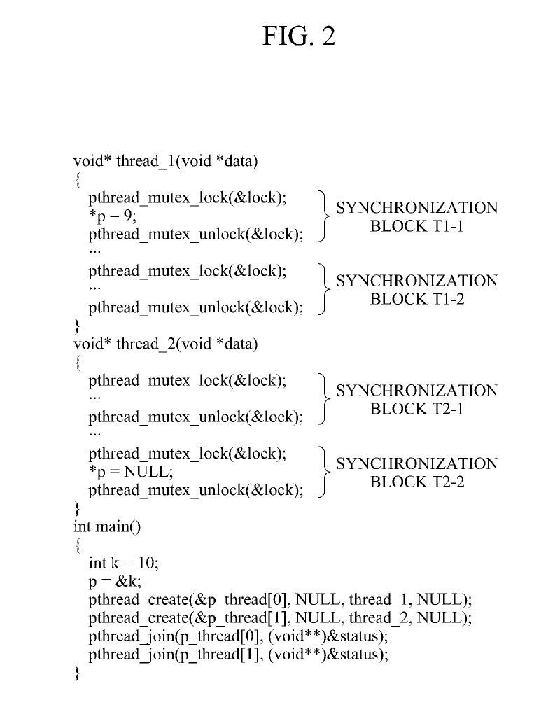

FIG. 2 illustrates an example of application source code, wherein a main function calls two thread functions “thread_1” and “thread_2”. In FIG. 2, a section of code in which “pthread_mutex_lock” and “pthread_mutex_unlock” are stacked in each of “thread_1” and “thread_2” is a synchronization block that is synchronized by the same variables “lock”. The “thread_1” includes two synchronization blocks “T1-1” and “T1-2”, and the “thread_2” includes two synchronization blocks “T2-1” and “T2-2”. The following description will be given with reference to FIGS. 1 and 2.

For example, referring again to the coverage apparatus 100 of FIG. 1, the synchronization block searching unit 110 may search for synchronization blocks by detecting portions of the application source code in which “pthread_mutex_lock” and “pthread_mutex_unlock” are stacked in the threads illustrated in FIG. 2.

The synchronization block pair defining unit 120 detects mutually exclusive synchronization blocks that can be simultaneously executed, from a plurality of threads including the found synchronization blocks, and associates the detected mutually exclusive synchronization blocks with each other to define mutually exclusive synchronization block pairs.

During the detecting of the mutually exclusive synchronization blocks, the synchronization block pair defining unit 120 may determine the execution precedence relationship between synchronization blocks included in two threads, and may detect the two synchronization blocks as mutually exclusive synchronization blocks in response to there being no execution precedence relationship between the two synchronization blocks.

For example, the execution precedence relationship between synchronization blocks may be determined using a vector clock technique. The vector clock technique includes detecting portions of code having execution precedence relationships to determine the execution order of each section of an application and which sections can be simultaneously executed.

Accordingly, the execution precedence relationship between synchronization blocks may be determined by using the vector clock technique to assign clock values to individual synchronization blocks to vectorize the synchronization blocks, to increase the clock values of synchronization blocks transmitting messages, and then to compare vector clocks to each other for each execution section. It is understood that the vector clock technique is merely one example of determining the execution precedence relationship between synchronization blocks, and other various methods may be employed in place of, or in combination with, the vector clock technique.

There is a possibility that synchronization blocks in one given thread are sequentially executed, while synchronization blocks in different threads are exclusively and simultaneously executed. In other words, while the synchronization blocks in a first and second thread may be sequentially executed in their respective threads, those same synchronization blocks may be exclusively and simultaneously executed in regard to the synchronization blocks in the other thread. The synchronization blocks having the possibility of being exclusively and simultaneously executed are referred to as “mutually exclusive synchronization blocks”.

In the example illustrated in FIG. 2, the synchronization blocks “T1-1” and “T1-2” included in “thread_1” are sequentially executed, and the synchronization blocks “T2-1” and “T2-2” included in “thread_2” are also sequentially executed. However, the synchronization block “T1-1” included in the “thread_1” may be exclusively and simultaneously executed with the respective synchronization blocks “T2-1” and “T2-2” included in the “thread_2”. Similarly, the synchronization block “T1-2” included in the “thread_1” may be exclusively and simultaneously executed with the respective synchronization blocks “T2-1” and T2-2″ included in the “thread_2”.

In order to induce execution conflictions of mutually exclusive synchronization blocks to perform coverage, the synchronization block pair defining unit 120 detects mutually exclusive synchronization blocks that can be simultaneously executed, from a plurality of threads each including a plurality of synchronization blocks, and associates the detected mutually exclusive synchronization blocks with each other to define mutually exclusive synchronization block pairs.

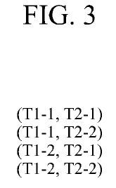

FIG. 3 illustrates mutually exclusive synchronization block pairs defined by the application source code illustrated in FIG. 2. As illustrated in FIG. 3, mutually exclusive synchronization block pairs (T1-1, T2-1), (T1-1, T2-2), (T1-2, T2-1) and (T1-2, T2-2) may be defined from the “thread_1” including the synchronization blocks “T1-1” and “T1-2” and the “thread_2” including the synchronization blocks “T2-1” and “T2-2”.

Referring again to the coverage apparatus 100 of FIG. 1, the scheduler 130 may schedule the execution order of the mutually exclusive synchronization block pairs to intentionally induce execution conflictions of the mutually exclusive synchronization blocks. If a certain application has two threads each including a synchronization block, a thread-based test may be performed which sequentially executes the two synchronization blocks and then again executes the synchronization blocks in the reverse order, thereby achieving 100% coverage.

However, as illustrated in FIG. 2, in an example in which there are a plurality of threads each including two or more synchronization blocks and the synchronization blocks included in the threads form mutually exclusive synchronization block pairs, the thread-based test may cause is a timing-related problem between the mutually exclusive synchronization blocks.

In order to overcome this and/or other testing problems, the coverage apparatus 100 of FIG. 1 may induce execution conflictions by causing the scheduler 120 to schedule the execution order of mutually exclusive synchronization block pairs such that the execution order includes all execution order combinations of the mutually exclusive synchronization block pairs, thereby maximizing coverage.

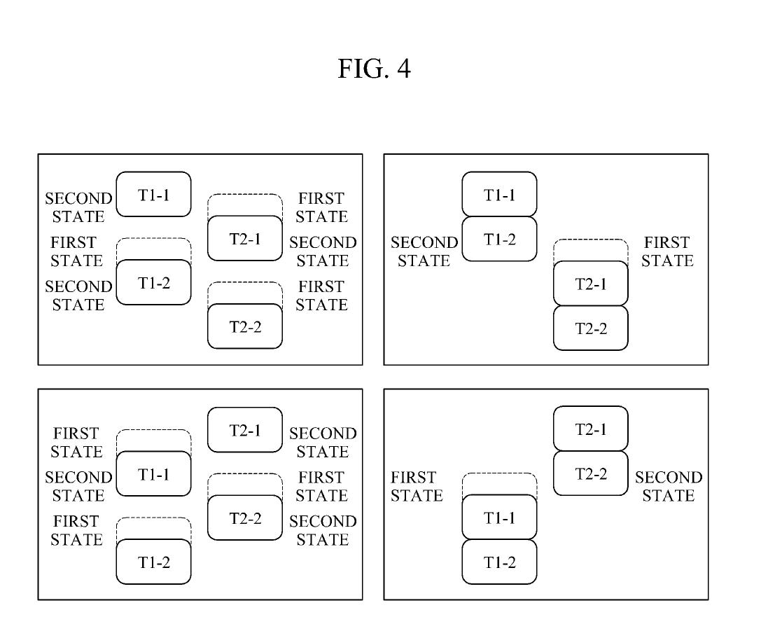

FIG. 4 illustrates scheduling examples of the execution order of the mutually exclusive synchronization block pairs illustrated in FIG. 3.

In FIG. 4, a state in which a current synchronization block is executed later than another synchronization block forming a mutually exclusive synchronization block pair with the current synchronization block, and thus waits without being executed until the other synchronization block of the pair has been executed, is defined as a first state. A state in which a current synchronization block is executed earlier than another synchronization block forming a mutually exclusive synchronization block pair with the current synchronization block, and thus blocks the other synchronization block from being executed until after the execution of the current synchronization block, is defined as a second state.

Referring again to the coverage apparatus 100 of FIG. 1, the coverage performing unit 140 may execute the mutually exclusive synchronization block pairs in the order scheduled by the scheduler 130 to perform coverage of the corresponding application, and may determine the result of the coverage performance.

That is, the coverage performing unit 140 may execute the mutually exclusive synchronization block pairs in the order scheduled as illustrated in FIG. 4 while causing intentional execution conflictions of the mutually exclusive synchronization blocks such that the mutually exclusive synchronization blocks accomplish the first and second states, to perform coverage of the corresponding application, and may confirm that no execution confliction occurs, thereby achieving coverage of the corresponding application.

The controller 150 may analyze the result of the coverage performance, and may determine whether to continue to perform or terminate coverage on the corresponding application based on the result of the coverage performance. In response to 100% coverage on the corresponding application is achieved, that is, in response to the mutually exclusive synchronization block pairs are all executed in the scheduled order, the controller 150 may determine that coverage on the corresponding application should be terminated. On the other hand, as another example, the controller 150 may determine, in response to there being no change in the result of the coverage performance after coverage is repeatedly performed a predetermined number of times, that coverage on the corresponding application should be terminated.

Accordingly, the coverage apparatus 100 may schedule the execution order of mutually exclusive synchronization block pairs in such a manner so as to intentionally induce execution conflictions of the mutually exclusive synchronization blocks, wherein the mutually exclusive synchronization block pairs are defined by associating synchronization blocks that are detected from a plurality of threads each including two or more synchronization blocks and that can be simultaneously executed, to perform coverage of the corresponding multi-threaded application, thereby efficiently testing the multi-threaded application.

According to another example, the coverage performing unit 140 of the coverage apparatus 100 may insert a first test unit and a second test unit, respectively, before and after synchronization blocks included in each of the plurality of threads, to test the first state in which a current synchronization block is executed later than another synchronization block forming a mutually exclusive synchronization block pair with the current synchronization block, and thus waits without being executed, and the second state in which a current synchronization block is executed earlier than another synchronization block forming a mutually exclusive synchronization block pair with the current synchronization block and thus delays the synchronization block from being executed. For example, the first and second test units may be configured in the form of functions.

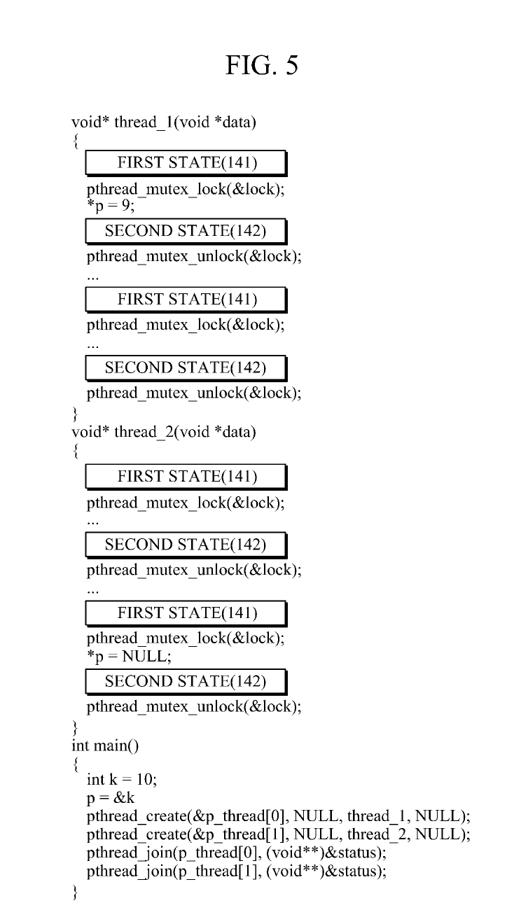

FIG. 5 illustrates a state in which first test units 141 and second test units 142 are inserted into the application source codes illustrated in FIG. 2. Referring to the example illustrated in FIG. 5, each first test unit 141 may be inserted before synchronization blocks included in each of “thread_1” and “thread_2”, that is, before “pthread_mutex_lock”, and each second test unit 142 may be inserted after the synchronization blocks included in each of “thread_1” and “thread_2”, that is, after “pthread_mutex_lock”.

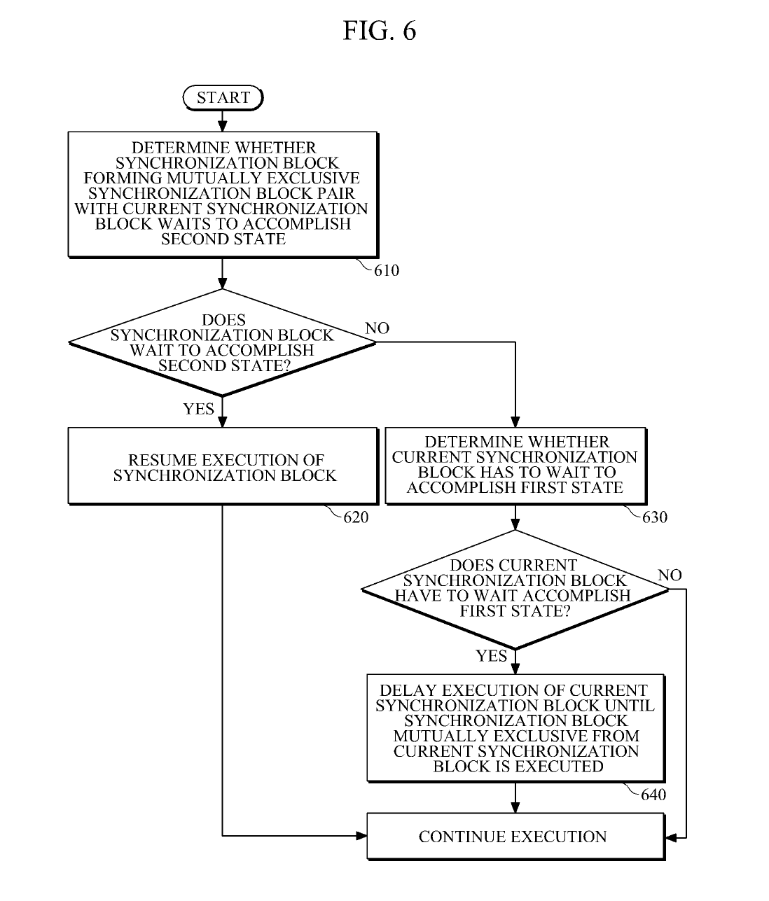

FIG. 6 is a flowchart illustrating an example of operation of the first test units 141, and

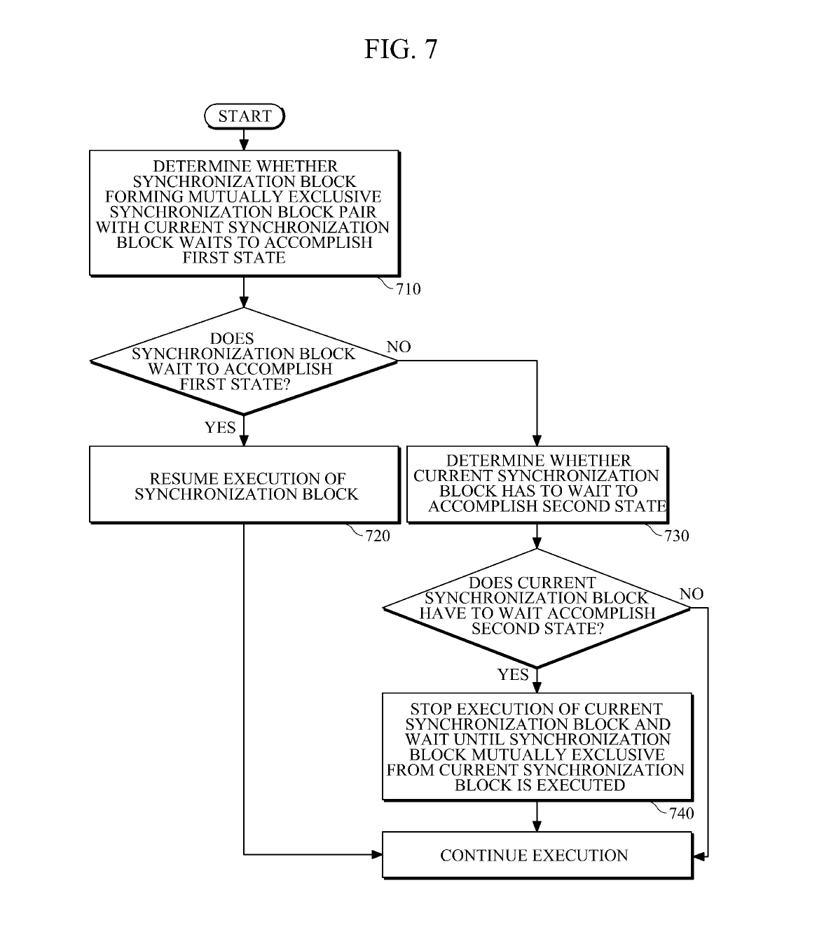

FIG. 7 is a flowchart illustrating an example of operation of the second test units 142. Hereinafter, the operation of the first and second test units 141 and 142 will be described with reference to FIGS. 6 and 7.

The first test units 141 may be respectively added before two or more synchronization blocks included in each thread, and may determine whether a synchronization block forming a mutually exclusive synchronization block pair with a current synchronization block waits to accomplish the second state (610), and resumes, in response to the mutually exclusive synchronization block waiting to accomplish the second state, execution of the mutually exclusive synchronization block (620).

In this way, coverage on the second state in which a synchronization block forming a mutually exclusive synchronization block pair with a current synchronization block is executed earlier than the current synchronization block and thus delays the current synchronization block from being executed is performed.

Conversely, coverage on the first state in which a current synchronization block is executed later than a synchronization block forming a mutually exclusive synchronization block pair with the current synchronization block and thus waits before being executed is performed.

Meanwhile, in a case in which a synchronization block forming the mutually exclusive synchronization block pair with the current synchronization block does not wait to accomplish the second state, the first test unit 141 determines whether the current synchronization block has to wait to accomplish the first state (630).

If it is determined that the current synchronization block has to wait to accomplish the first state, the first test unit 141 delays execution of the current synchronization block until the synchronization block mutually exclusive from the current synchronization block is executed (640).

If the synchronization block mutually exclusive from the current synchronization block is executed while execution of the current synchronization block is delayed, execution of the current synchronization block is resumed to perform coverage on the first state in which a current synchronization block is executed later than a synchronization block forming a mutually exclusive synchronization block pair with the current synchronization block and thus waits before being executed.

Conversely, coverage on the second state in which a synchronization block forming a mutually exclusive synchronization block pair with a current synchronization block is executed earlier than the current synchronization block and thus delays the current synchronization block from being executed is performed.

The second test unit 142 may be added between synchronization blocks included in each thread, and may determine whether a synchronization block forming a mutually exclusive synchronization block pair with the current synchronization block waits to accomplish the first state (710), and resumes execution of the synchronization block mutually exclusive from the current synchronization block in response to the mutually exclusive synchronization block waiting to accomplish the first state (720).

In this way, coverage on the first state in which a synchronization block forming a mutually exclusive synchronization block pair with a current synchronization block is executed later than the current synchronization block and thus waits before being executed is performed.

Conversely, coverage on the second state in which the current synchronization block forming a mutually exclusive synchronization block pair with the synchronization block is executed earlier than the synchronization block and thus delays the synchronization block from being executed is performed.

Meanwhile, in a case in which a synchronization block forming a mutually exclusive synchronization block pair with the current synchronization block does not wait to accomplish the first state, the second test unit 142 determines whether the current synchronization block has to wait to accomplish the second state (730).

If it is determined that the current synchronization block has to wait to accomplish the second state, the second test unit 142 stops execution of the current synchronization block and waits until the synchronization block mutually exclusive from the current synchronization block is executed (740).

Before the mutually exclusive synchronization block is executed while execution of the current synchronization block is stopped, execution of the current synchronization block is resumed, thereby performing coverage on the second state in which a current synchronization block is executed earlier than a synchronization block forming a mutually exclusive synchronization block pair with the current synchronization block and thus delays the synchronization block from being executed.

Conversely, coverage on the first state in which a synchronization block forming a mutually exclusive synchronization block pair with a current synchronization block is executed later than the current synchronization block and thus waits before being executed is performed.

That is, by using the first and second test units 141 and 142 to test the first and second states with respect to all combinations of mutually exclusive synchronization block pairs included in a plurality of threads, and confirming that no execution confliction occurs in response to all combinations of the mutually exclusive synchronization block pairs being executed, coverage of the corresponding multi-threaded application is accomplished. In this way, the multi-threaded application can be efficiently tested.

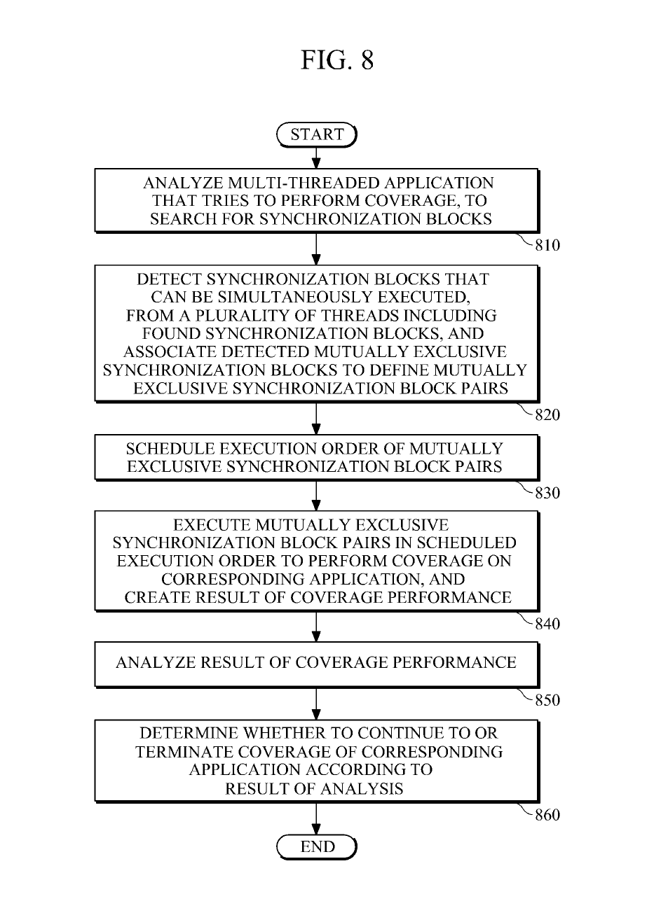

A coverage method of the coverage apparatus 100 (see FIG. 1) described above will be described with reference to FIG. 8. FIG. 8 is a flowchart illustrating an example of a coverage method which is performed by the coverage apparatus 100 for testing a multithreading environment.

First, the coverage apparatus 100 analyzes a multi-threaded application that tries to perform coverage, and searches for synchronization blocks from the application (810). Searching for synchronization blocks from an application has been described above and accordingly details thereof will be omitted.

The coverage apparatus 100 detects mutually exclusive synchronization blocks that can be simultaneously executed, from a plurality of threads including the found synchronization blocks, and associates the detected mutually exclusive synchronization blocks to define mutually exclusive synchronization block pairs (820). A method of detecting mutually exclusive synchronization blocks and defining mutually exclusive synchronization block pairs also has been described above, and accordingly a detailed description thereof will be omitted.

The coverage apparatus 100 schedules the execution order of the mutually exclusive synchronization block pairs in such a manner so as to intentionally induce execution conflictions of the mutually exclusive synchronization blocks (830). A method of scheduling the execution order of mutually exclusive synchronization block pairs has been described above, and accordingly a detailed description thereof will be omitted.

That is, for efficient coverage of a multi-threaded application, at operation 830, by scheduling the execution order of the mutually exclusive synchronization block pairs in such a manner so as to intentionally induce execution conflictions of the mutually exclusive synchronization blocks, coverage is maximized.

The coverage apparatus 100 executes the mutually exclusive synchronization block pairs in the scheduled order to perform coverage of the corresponding application, and determines the result of the coverage performance (840).

At this time, first and second test units may be added before and after a plurality of synchronization blocks included in each thread, respectively, to test the first state in which a current synchronization block is executed later than a synchronization block forming a mutually exclusive synchronization block pair with the current synchronization block and thus waits before being executed, and the second state in which a current synchronization block is executed earlier than a synchronization block forming a mutually exclusive synchronization block pair with the current synchronization block and thus delays the synchronization block from being executed. The first and second test units also have been described above, and accordingly a detailed description thereof will be omitted.

In this way, by intentionally inducing execution conflictions with respect to all combinations of mutually exclusive synchronization block pairs such that all combinations of the mutually exclusive synchronization block pairs accomplish the first and second states, to perform coverage of the corresponding application, and confirming that no execution confliction occurs in response to all combinations of the mutually exclusive synchronization block pairs being executed, coverage on the corresponding application is accomplished.

The coverage apparatus 100 analyzes the result of the coverage performance (850), and determines whether to continue to or terminate coverage of the corresponding application according to the result of the analysis (860).

In response to 100% coverage being accomplished, that is, in response to the mutually exclusive synchronization block pairs all being executed in the scheduled order, the coverage apparatus 100 may determine that coverage of the corresponding application may be terminated. Alternatively, in response to there being no change in the result of the coverage performance after the coverage is repeated a predetermined number of times, the coverage apparatus 100 may determine that coverage of the corresponding application may be terminated.

In this way, the coverage apparatus 100 schedules the execution order of mutually exclusive synchronization block pairs in such a manner so as to intentionally induce execution conflictions of the mutually exclusive synchronization blocks, wherein the mutually exclusive synchronization block pairs are defined by associating synchronization blocks that are detected from a plurality of threads each including two or more synchronization blocks and that can be simultaneously executed, to perform coverage of the application, thereby efficiently testing the multi-threaded application.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A coverage apparatus to test a multithreading environment, comprising:
a synchronization block searching unit configured to analyze a multi-threaded application, and to search for a plurality of synchronization blocks from the multi-threaded application;
a synchronization block pair defining unit configured to detect mutually exclusive synchronization blocks, that are simultaneously executable, from a plurality of threads including found synchronization blocks, and to associate the detected mutually exclusive synchronization blocks to define one or more mutually exclusive synchronization block pairs;
a scheduler configured to schedule an execution order of the mutually exclusive synchronization block pairs to induce execution conflictions of the mutually exclusive synchronization blocks;
a coverage performing unit configured to execute the mutually exclusive synchronization block pairs in the scheduled execution order to perform coverage on the multi-threaded application, and to determine the result of the coverage performance; and
a controller configured to analyze the result of the coverage performance to determine whether to continue to perform or terminate the coverage on the multi-threaded application.

2. The coverage apparatus of claim 1, wherein the synchronization block pair defining unit determines an execution precedence relationship between one synchronization block included in one thread and another synchronization block included in another thread, and detects, in response to there being no execution precedence relationship between the two synchronization blocks, the two synchronization blocks as the mutually exclusive synchronization blocks.

3. The coverage apparatus of claim 1, wherein the coverage performing unit inserts a first test unit and a second test unit, respectively, before and after synchronization blocks included in each of the plurality of threads, to test a first state in which a current synchronization block is executed later than another synchronization block forming a mutually exclusive synchronization block pair with the current synchronization block and thus waits before being executed, and a second state in which the current synchronization block is executed earlier than the other synchronization block forming the mutually exclusive synchronization block pair with the current synchronization block and thus delays the other synchronization block from being executed.

4. The coverage apparatus of claim 3, wherein the first test unit is added before the synchronization blocks included in each of the plurality of threads, and determines whether the other synchronization block forming the mutually exclusive synchronization block pair with the current synchronization block waits to accomplish the second state, and resumes, in response to the other synchronization block waiting, execution of the other synchronization block.

5. The coverage apparatus of claim 4, wherein in response to the other synchronization block forming the mutually exclusive synchronization block pair with the current synchronization block not waiting to accomplish the second state, the first test unit determines whether the current synchronization block has to wait to accomplish the first state, and if it is determined that the current synchronization block has to wait to accomplish the first state, the first test unit delays execution of the current synchronization block until the other synchronization block mutually exclusive from the current synchronization block is executed.

6. The coverage apparatus of claim 3, wherein the second test unit is added between the synchronization blocks included in each of the plurality of threads, and determines whether the other synchronization block forming the mutually exclusive synchronization block pair with the current synchronization block waits to accomplish the first state, and resumes execution of the other synchronization block in response to the synchronization block waiting to accomplish the first state.

7. The coverage apparatus of claim 6, wherein in response to the other synchronization block forming the mutually exclusive synchronization block pair with the current synchronization block not waiting to accomplish the first state, the second test unit determines whether the current synchronization block has to wait to accomplish the second state, and if it is determined that the current synchronization block has to wait to accomplish the second state, the second test unit stops execution of the current synchronization block and waits until the other synchronization block mutually exclusive from the current synchronization block is executed.

8. The coverage apparatus of claim 1, wherein in response to the mutually exclusive synchronization block pairs all being executed in the scheduled order, the controller determines that coverage on the multi-threaded application is to be terminated.

9. The coverage apparatus of claim 1, wherein in response to there being no change in the result of the coverage performance after coverage is repeatedly performed a predetermined number of times, the controller determines that coverage on the multi-threaded application is to be terminated.

10. A coverage method of testing a multithreading environment, comprising:
analyzing a multi-threaded application, and searching for a plurality of synchronization blocks from the multi-threaded application;
detecting mutually exclusive synchronization blocks, that are simultaneously executable, from a plurality of threads including found synchronization blocks, and associating the detected mutually exclusive synchronization blocks to define one or more mutually exclusive synchronization block pairs;
scheduling an execution order of the mutually exclusive synchronization block pairs to induce execution conflictions of the mutually exclusive synchronization blocks;
executing the mutually exclusive synchronization block pairs in the scheduled execution order to perform coverage on the multi-threaded application, and determining the result of the coverage performance;
analyzing the result of the coverage performance; and
determining whether to continue to perform or terminate the coverage on the multi-threaded application, according to the analyzed result of the coverage performance.

11. The coverage method of claim 10, wherein the defining of the one or more mutually exclusive synchronization block pairs comprises determining an execution precedence relationship between one synchronization block included in one thread and another synchronization block included in another thread, and detecting, in response to there being no execution precedence relationship between the two synchronization blocks, the two synchronization blocks as the mutually exclusive synchronization blocks.

12. The coverage method of claim 10, wherein the executing of the mutually exclusive synchronization block pairs in the scheduled execution order to perform coverage on the multi-threaded application comprises inserting a first test unit and a second test unit, respectively, before and after synchronization blocks included in each of the plurality of threads, to test a first state in which a current synchronization block is executed later than another synchronization block forming a mutually exclusive synchronization block pair with the current synchronization block and thus waits before being executed, and a second state in which the current synchronization block is executed earlier than the other synchronization block forming the mutually exclusive synchronization block pair with the current synchronization block and thus delays the other synchronization block from being executed.

13. The coverage method of claim 12, wherein in the executing of the mutually exclusive synchronization block pairs in the scheduled execution order to perform coverage on the multi-threaded application, the first test unit is added before the synchronization blocks included in each of the plurality of threads, and determines whether the other synchronization block forming the mutually exclusive synchronization block pair with the current synchronization block waits to accomplish the second state, and resumes, in response to the other synchronization block waiting, execution of the other synchronization block.

14. The coverage method of claim 12, wherein in the executing of the mutually exclusive synchronization block pairs in the scheduled execution order to perform coverage on the multi-threaded application, in response to the other synchronization block forming the mutually exclusive synchronization block pair with the current synchronization block not waiting to accomplish the second state, the first test unit determines whether the current synchronization block has to wait to accomplish the first state, and if it is determined that the current synchronization block has to wait to accomplish the first state, the first test unit delays execution of the current synchronization block until the other synchronization block mutually exclusive from the current synchronization block is executed.

15. The coverage method of claim 12, wherein in the executing of the mutually exclusive synchronization block pairs in the scheduled execution order to perform coverage on the multi-threaded application, the second test unit is added after the synchronization blocks included in each of the plurality of threads, and determines whether the other synchronization block forming the mutually exclusive synchronization block pair with the current synchronization block waits to accomplish the first state, and resumes execution of the other synchronization block in response to the synchronization block waiting to accomplish the first state.

16. The coverage method of claim 15, wherein in the executing of the mutually exclusive synchronization block pairs in the scheduled execution order to perform coverage of the multi-threaded application, in response to the other synchronization block forming the mutually exclusive synchronization block pair with the current synchronization block not waiting to accomplish the first state, the second test unit determines whether the current synchronization block has to wait to accomplish the second state, and if it is determined that the current synchronization block has to wait to accomplish the second state, the second test unit stops execution of the current synchronization block and waits until the other synchronization block mutually exclusive from the current synchronization block is executed.

17. The coverage method of claim 10, wherein the determining of whether to continue to perform or terminate coverage on the multi-threaded application comprises determining, in response to the mutually exclusive synchronization block pairs all being executed in the scheduled order, that coverage on the multi-threaded application is to be terminated.

18. The coverage method of claim 10, wherein the determining of whether to continue to perform or terminate coverage on the multi-threaded application comprises determining, in response to there being no change in the result of the coverage performance after coverage is repeatedly performed a predetermined number of times, that coverage on the multi-threaded application is to be terminated.

19. A coverage method of testing a multithreading environment, comprising:
detecting mutually exclusive synchronization blocks that are simultaneously executable from a plurality of threads;
defining exclusive synchronization block pairs with pairs of the exclusive synchronization blocks detected in different threads;
executing the mutually exclusive synchronization block pairs in various orders to perform coverage testing.

20. The coverage method of claim 19, wherein at least one of the mutually exclusive synchronization block pairs is executed in a first order in which a first block is delayed until after a second block is executed, and in a second order in which the second block is delayed until after the first block is executed.
